(19) United States
(12) Patent Application Publication
(10) Pub. No.: US 2010/0031788 A1
(43) Pub. Date: Feb. 11, 2010

(54) SYSTEMS, METHODS AND DEVICES FOR BEVELING AN EDGE OF AN OBJECT

(76) Inventor: Gustave F. Gudleske, Cameron Park, CA (US)

Correspondence Address: LATHROP & CLARK LLP, 740 REGENT STREET SUITE 400, P.O. BOX 1507, MADISON, WI, 537011507, US

(21) Appl. No.: 12/443,382

(22) PCT Filed: Sep. 27, 2007
(86) PCT No.: PCT/US2007/079676

§ 371 Date: Mar. 27, 2009

Related U.S. Application Data
(60) Provisional application No. 60/827,195, filed on Sep. 27, 2006.

(51) Int. Cl. B23B 5/16; B24B 9/00

(52) U.S. Cl. 82/1.11; 451/541; 82/113

(57) ABSTRACT

A bevel cutting system is attachable to a rotary device and comprises one or more bevel cutting devices having a same axis of rotation, that are combined together and that bevel objects having different diameters. The bevel cutting devices are attached to the same rotary drive spindle as a cutting blade of the rotary device. Each bevel cutting device comprises an annular wall extending away from the cutting blade. The annular wall has an inwardly-facing surface that is angled inwardly relative to their axis of rotation. An abrasive or a material removing pattern is provided on and/or in the angled inwardly-facing surface. A removable strip can be attached to the angled inwardly-facing surface. This removable strip can include an abrasive and/or a material-removing pattern or the like. The removable strip can be attached using an adhesive and/or mechanical fasteners. Cutting elements can be distributed around the inwardly-facing surface.

This application claims priority to U.S. Provisional Patent application 60/827,195, filed Sep. 27, 2006, which is incorporated herein by reference in its entirety.

### BACKGROUND OF THE INVENTION

1. Field of the Invention

This invention relates to devices, systems and methods usable to bevel an object.

2. Related Art

A standard pipe used in underground systems generally has a “straight” end and a “bell” end. These underground systems can be water main or deliver systems, stormwater drainage systems, sewer systems, underground electrical supply systems and/or any other known or later-developed underground system where fluids need to be maintained within the pipes or fluid needs to be be kept from entering into the pipes from the outside environment. The pipe is sealed by plugging the straight end of one pipe into the bell end of the next pipe or of another part in the underground water system. A lip seal is typically located inside the bell end. The straight end of the pipe slides through the lip seal to form a seal. The pipe is produced in standard lengths with a milled or beveled edge on the straight end to allow the straight end of the pipe to slide past the lip seal in the bell end without damaging the lip seal. Often, a standard length pipe must be shortened, such as, for example, to fit into a joint or elbow to go around a corner. However, after the pipe is cut, the straight end of the pipe no longer has the factory-milled bevel.

In various prior methods, the pipe is rolled or rotated through a number of complete turns to obtain a pipe that is both cut to the desired length and has a straight end having a bevel. One such method for cutting and milling pipe uses a standard cut-off saw to cut the pipe as the pipe is rolled or rotated a first time and then uses a standard hand grinder to put a bevel on the pipe as the pipe is rolled or rotated a second time. This two-tool method is time consuming, requires the use of two separate tools, and requires that the pipe must be rolled or rotated twice.

Another such method for cutting and beveling pipe uses a standard cut-off saw to cut the pipe as the pipe is rolled or rotated a first time and then uses the same cut-off saw to put a bevel on the pipe as the pipe is rolled or rotated a second time. This method is not approved by OSHA. Like the two-tool method, this method requires that the pipe be rolled twice, once to cut the page to the desired length and once again to mill the bevel onto the cut-down straight end of the pipe. Also, this method is particularly time consuming and generally produces poor quality results.

Reed Manufacturing Company produces universal pipe cutters (UPC). Universal pipe cutters are popular because, by choosing the proper blade, they are capable of cutting a pipe made from a wide variety different materials including PVC, PE, cast iron, ductile iron, and vitreous clay. Also, universal pipe cutters can be used in many locations including above ground, below ground, such as in a ditch, and under water. Further, only one rotation is needed to cut most types of pipes. However, operating these universal pipe cutters is far from simple. Some of the operational steps include wrapping a chain around the pipe to secure the cutter to the pipe, connecting the chain, tightening a turnbuckle, attaching a power source, feeding a blade, and pulling the cutting apparatus clockwise around the pipe. Another problem with Reed's universal pipe cutters is the large quantity of equipment and accessories necessary to cut a pipe. For example, in addition to the blade and cutter, a Reed universal pipe cutter would need a chain with a turnbuckle, an air or hydraulic driven motor with a hose system, a filter, a regulator, a lubricator, a water tank with a cart, a hex key set, oil and/or grease, metal wedges, and a set of wrenches. Further, setting up this system is relatively complicated and time consuming.

One type of blade usable with Reed universal pipe cutters can be used to bevel the end of a pipe. The Reed bevel blade is a cylindrical wedge-shaped body that has a plurality of integral teeth. This bevel blade may be used to create a beveled edge. However, if a tooth dulls or breaks, the bevel blade becomes ineffective or useless. The blade must then be returned to a machine shop for any type of repair or maintenance. Such maintenance and repair, therefore, is both time consuming and costly.

U.S. Pat. No. 6,079,302, which is incorporated herein by reference in its entirety, discloses a saw blade and bevel cutter combination that can be used with a standard cut-off saw or other type of rotating or rotary device. As disclosed in the incorporated '302 Patent, the bevel cutter is attached to the cut-off saw along the same rotational axis as the saw blade. The bevel cutter has a first face that rests against the saw blade. The bevel cutter has an angled outer surface that extends from the saw blade and the first face. A plurality of cutting elements are distributed around the angled outer surface. In operation, the saw blade and the bevel cutter rotate together. As the pipe is cut by the saw blade, the cutting elements of the bevel cutter contact and cut or mill a bevel into the cut end of the pipe. The pipe is rotated about one full turn, to present new material for the saw blade to cut and a new cut end of the pipe for the bevel cutter to bevel.

### SUMMARY OF THE DISCLOSED EMBODIMENTS

The saw blade and bevel cutter combination disclosed in the incorporated '302 Patent is very useful, especially for larger size pipes, such as those having a diameter greater than the diameter of the saw blade. However, in the typical set up for this device, as disclosed in the incorporated '302 Patent, smaller-diameter pipes having diameters less than the diameter of the saw blade, such as those of about 8 inches and less, must be handled the same way that larger diameter pipes are handled. However, such smaller-diameter pipes are lighter and more-easily maneuvered. It would be advantageous to have a beveling device usable to generally bevel an edge of an object. It would be advantageous to have a beveling device that could be combined with a saw blade of a cut-off saw or the like that can take advantage of these differences of smaller-diameter pipes.

This invention provides at least one beveling device having an inwardly-facing beveling surface.

This invention separately provides at least one beveling device, where each beveling device has a continuous beveling surface.

This invention separately provides for at least two beveling devices, where each beveling device has a same axis of rotation or a same center point.

This invention separately provides at least two beveling devices, where one beveling device nests inside another beveling device.

This invention separately provides for a bevel cutting system having at least one bevel cutting device having a disposable bevel cutting surface.

This invention separately provides for a bevel cutting system having at least one bevel cutting device having a replaceable bevel cutting surface.

This invention separately provides for a bevel cutting system having at least one disposable bevel cutting device.

This invention separately provides for a bevel cutting system having at least one replaceable bevel cutting device.

In various exemplary embodiments of devices, systems and methods for beveling an object according to this invention, a bevel cutting system comprises one or more bevel cutting devices. Each bevel cutting device has a same axis of rotation or a same center point. In various exemplary embodiments, the bevel cutting system is attachable to a cut-off saw or other type of rotary saw or other rotary device. In such exemplary embodiments, the bevel cutting devices have the same axis of rotation as a cutting blade of the cut-off saw or the like that the bevel cutting systems is attached to. In various exemplary embodiments, the bevel cutting system is attached to the same rotary drive spindle that the cutting blade is attached to.

In various exemplary embodiments, after the cutting blade is placed around the rotary device spindle of the cutting tool, an adaptor is placed around the rotary drive spindle and a nut is threaded onto the rotary drive spindle and tightened against the adaptor to tightly hold both the cutting blade and the adaptor to the rotary drive spindle. In various exemplary embodiments, one or more bevel cutting devices are placed around the adaptor. A second nut is then threaded onto the adaptor and tightened to hold the one or more bevel cutting devices so that the one or more bevel cutting devices rotate with the cutting blade.

In various exemplary embodiments, each bevel cutting device comprises an annular wall extending away from the cutting blade. The annular wall has an inwardly-facing surface that is angled inwardly relative to the axis of rotation of the bevel cutting devices. The annular wall extends from a base or other connecting structure that connects the annular wall to the adaptor so that the annular wall and the base or other connection structure rotate with the cutting blade. In various exemplary embodiments, the base or other connection structure is integrally formed with the annular wall. In various exemplary embodiments, an abrasive material is provided on and/or in the angled inwardly-facing surface. In various other exemplary embodiments, a cutting, rasping or other material-removing pattern is formed in the angled inwardly-facing surface. In various other exemplary embodiments, each bevel cutting device comprises a number of spaced-apart portions or sectors of the annular wall, rather than a continuous annular wall.

In various other exemplary embodiments, a removable layer or strip of material is attached to the angled inwardly-facing surface. This removable layer or strip can include an abrasive material and/or a material-removing pattern or the like. In various exemplary embodiments, the removable layer or strip can be attached using an adhesive and/or using mechanical fastener(s). In various other exemplary embodiments, one or more cutting elements are distributed around the circumference of the inwardly-facing surface. Such cutting elements can be similar to those disclosed in the incorporated '302 Patent.

In various exemplary embodiments, the bevel cutting system includes a number of different bevel cutting devices that can be combined together. Each different bevel cutting device is usable to bevel a pipe having a different diameter. In various exemplary embodiments, the bevel cutting devices for a smaller-diameter pipe are nested inside the bevel cutting device for a larger-diameter pipe.

These and other features and advantages or various exemplary embodiments of systems and methods according to this invention will be described in greater detail below with respect to the exemplary embodiments shown in the attached figures.

### BRIEF DESCRIPTION OF DRAWINGS

Various exemplary embodiments of the systems and methods according to this invention will be described in detail, with reference to the following figures, wherein:

FIG. 1 shows a side perspective view of a cutting tool that includes one exemplary embodiment of a bevel cutting system according to this invention;

FIG. 2 is a side plan view of the cutting tool and the bevel cutting system shown in FIG. 1;

FIG. 3 is a side perspective view showing in greater detail the bevel cutting system;

FIG. 4 is a side perspective view showing in greater detail a first exemplary embodiment of a single bevel cutter;

FIG. 5 is a side plan view of the bevel cutter shown in FIG. 4;

FIG. 6 is a first cross-sectional view of the bevel cutter shown in FIGS. 4 and 5;

FIG. 7 is a side perspective view showing in greater detail a second exemplary embodiment of a single bevel cutter;

FIG. 8 is a cross-sectional view of the bevel cutter shown in FIG. 7;

FIG. 9 is a side perspective view showing in greater detail a third exemplary embodiment of a single bevel cutter;

FIG. 10 is a cross-sectional view of the bevel cutter shown in FIG. 9; and

FIG. 11 is a second cross-sectional view of the bevel cutter shown in FIG. 4.

### DETAILED DESCRIPTION OF DISCLOSED EMBODIMENTS

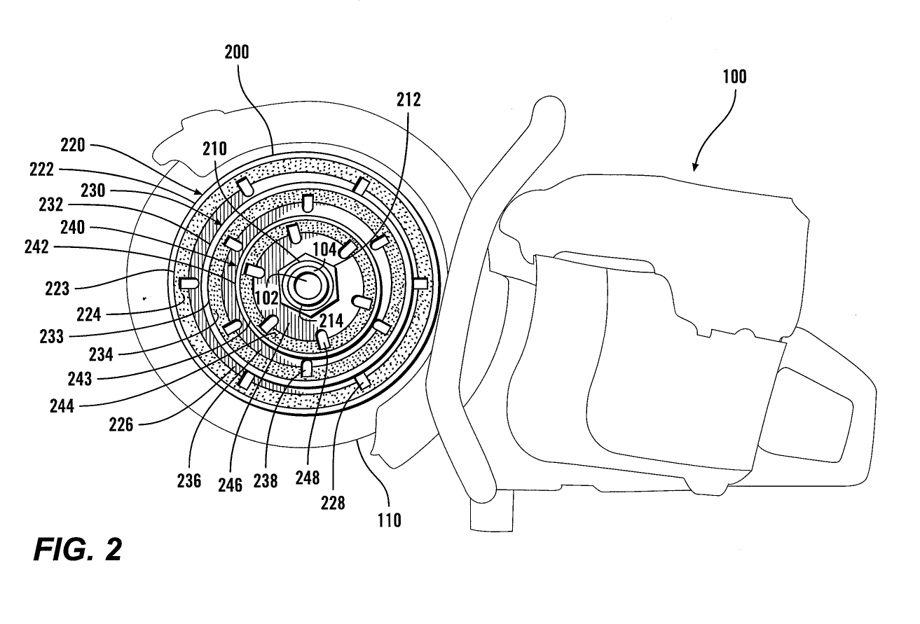

As shown in FIG. 2 of the incorporated '302 Patent, connections between two lengths of a standard water main pipe 10 are usually accomplished by inserting a “narrow” end 12 of a first length of water main pipe 10 into a “bell” end 14 of a second length of water main pipe 10 or some other part of the water supply system. A milled or beveled edge 16 on the narrow end 12 helps create a water tight seal between the narrow end 12 and the bell end 14.

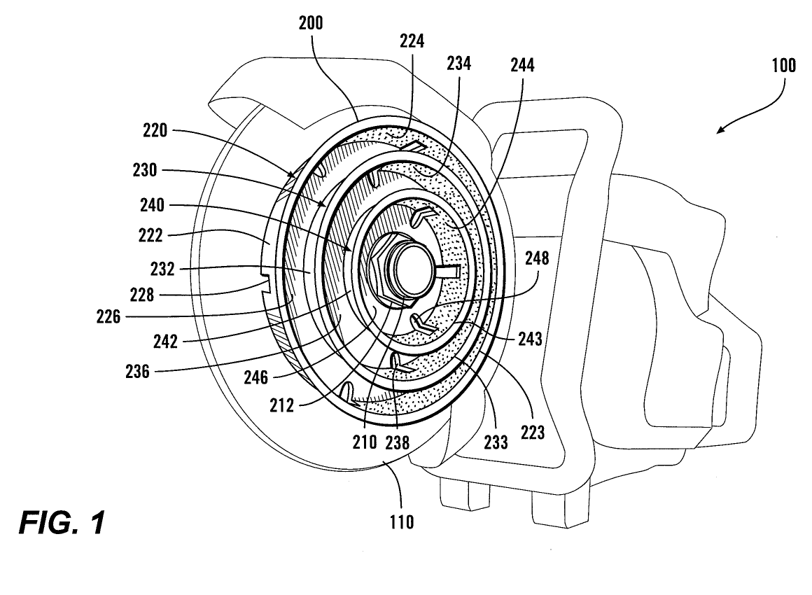

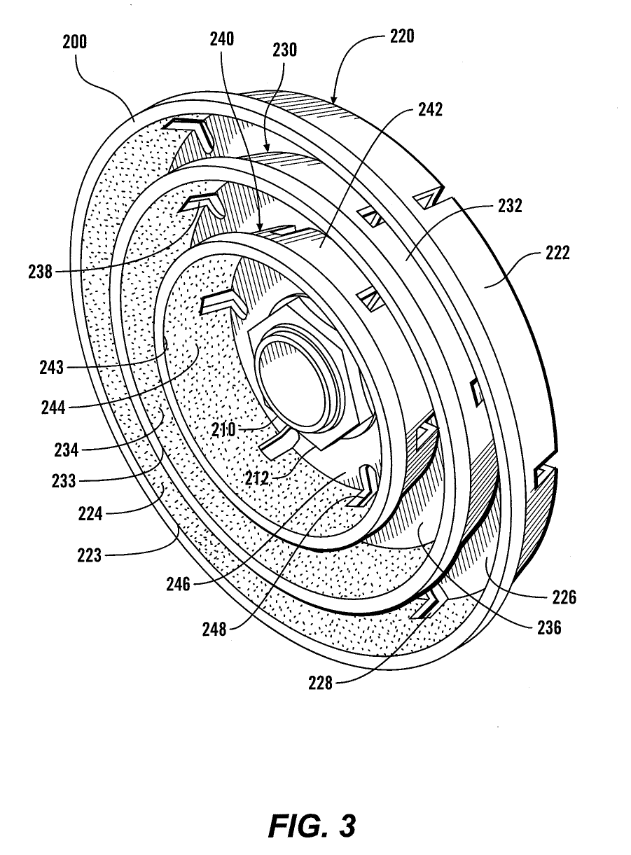

FIG. 1 shows a side perspective view of a cutting tool 100 having a cutting blade 110 that includes one exemplary embodiment of a bevel cutting system 200 according to this invention. FIG. 2 is a side plan view of the cutting tool 100 and the bevel cutting system 200 shown in FIG. 1. FIG. 3 is a side perspective view showing in greater detail one exemplary embodiment of the bevel cutting system 200.

As shown in FIGS. 1-3, the cutting tool 100 has a spindle 102 and a nut 104. Normally, the cutting blade 110 is placed on the spindle 102 and the nut 104 is threaded onto the spindle 102. The nut 104 is normally tightened against the cutting blade 110 to tightly hold the cutting blade 110 onto the spindle 102 as the cutting tool 100 is used to cut various articles. It should be appreciated that the cutting tool 100 can be a circular saw, a cut-off saw, a miter saw, a chop saw or any other known or later-developed type of tool that has a rotating spindle that is used to carry and rotate a cutting blade 110 or any other known or later-developed rotatable element. It should be appreciated that the cutting blade 110 can be any type of known or later-developed type of cutting blade, including a toothed blade, a tile blade, an abrasive blade or any other type of cutting blade.

As shown in FIGS. 1-3, the bevel cutting system 200 includes one or more of a number of bevel cutting devices 220-240, each having a different diameter, along with a spindle adaptor 210 and a nut 212. As shown in FIGS. 2 and 3, the spindle adaptor 210 has a base 214 having a central hole that is placed around the spindle 102 along with the cutting blade 110. Accordingly, when the nut 104 is threaded onto the spindle 102 and tightened, the nut 104 presses the base 214 of the spindle adaptor 210 tightly against the cutting blade 110 so that the spindle adaptor 210 rotates with the cutting blade 110 and the spindle 102.

Each of the bevel cutting devices 220, 230 and 240 has a base 226, 236 and 246, respectively, having a hole (not shown) that allows the bevel cutting device 220, 230 or 240 to be placed around the spindle adaptor 210. The nut 212 can be threaded onto the spindle adaptor 210 and tightened to press the bevel cutting devices 220, 230 and/or 240 tightly against the spindle adaptor 210 and/or the cutting blade 110 so that the bevel cutting devices 220, 230 and/or 240 rotate with the spindle 102 and the cutting blade 110.

As shown in FIGS. 1-3, each of the bevel cutting devices 220, 230 and 240 has an annular wall 222, 232 and 242, respectively, that extends from the respectively base 226, 236 or 246 away from the cutting blade 110. Each of the annular walls 222, 232 and 242 has a slanted or angled inner face 223, 233 and 243, respectively. These angled inner faces 223, 233 and 243 are angled inwardly toward the cutting blade 110, such that the axially inner ends of the angled inner faces 223, 233 and 243 are radially inward of the axially outer ends of the angled inner faces 223, 233 and 243. Thus, the angled inner faces 223, 233 and 243 form obtuse angles with their respective bases 226, 236 and 246.

In the exemplary embodiment shown in FIGS. 1-3, an abrasive material is attached to, formed onto, coated onto, embedded into, and/or otherwise associated with the angled inner faces 223, 233 and 243, respectively to form an abrasive layer 224, 234 and 244, respectively. It should be appreciated that, in various other exemplary embodiments, a material removing surface pattern, such as, for example, a knurled surface pattern, can be formed on the angled inner faces 223, 233 and/or 243. In various exemplary embodiments, rather than attaching an abrasive material to the angled inner faces 223, 233 and/or 243, respectively, to form the abrasive layer, 224, 234 and 244, respectively, a separate layer or strip of material carrying the abrasive material or having a material-removing pattern can be attached to the angled inner faces 223, 233 or 243.

In the specific exemplary embodiment shown in FIGS. 1-3, the abrasive layers 224, 234 and 244 have been thermally sprayed onto the inner faces 223, 233 and 243. It should be appreciated that any known or later developed thermal spray technique can be used to form the abrasive layers 224, 234 and 244. Likewise, it should be appreciated that any starting material that results in abrasive layers that have a desired level of roughness, abrasion and/or wear resistance can be used in the implemented thermal spray technique. In various exemplary embodiments, an electric arc thermal spraying technique is used to form the abrasive layers 224, 234 and/or 244 using 420 stainless steel wire as a starting material. The resulting abrasive layers 224, 234 and/or 244 includes iron oxides and chromium oxides. In various other exemplary embodiments, the abrasive layers 224, 234 and 244 comprise removable strips of grit or sand paper that has been adhered or glued to the respective angled inner faces 223, 233 and 243. The strip can be formed using paper, plastic, metal, fabric or any other usable material.

In this exemplary embodiment, when the cutting tool 100 is operated to rotate the spindle 102, the bevel cutting devices 220-240 of the bevel cutting system 200 rotate along with the cutting blade 110. A pipe or other object formed of a material, which is softer than the abrasive material or the material in which the material-removing pattern is formed, can be inserted into the specific bevel cutting device 220, 230 or 240 that is appropriate for the outside diameter of that pipe or other object. As the pipe or other object is inserted into the appropriate bevel cutting device 220, 230 or 240, the end of that pipe or other object contacts the abrasive material or material-removing pattern, which begins removing material from that end and/or the outer surface of that pipe or other object.

A user can continue to insert the pipe or other object into the appropriate bevel cutting device 220, 230 or 240 until the end of the pipe or other object contacts the base 226, 236 or 246, respectively. Accordingly, the abrasive material or material-removing pattern cuts a bevel into the inserted end of the pipe or other object. The depth and angle of the bevel depend on one or more of the angles of the angled inner face 223, 233 or 243 of the appropriate bevel cutting device 220, 230 or 240, respectively and the height that the annular wall 222, 232 or 242 extends away from the respective base 226, 236 or 246.

It should be appreciated that, in various other exemplary embodiments, the bevel cutting devices 220, 230 and/or 240 can be mounted onto a non-rotating mounting element. In such exemplary embodiments, rather than rotating the bevel cutting devices 220, 230 and/or 240 around a stationary pipe, the pipe is rotated within the stationary bevel cutting devices 220, 230 and/or 240. It should be appreciated that any known or later-developed technique, system and/or apparatus can be used to rotate the pipe.

It should be appreciated that, in still other exemplary embodiments, the cutting teeth disclosed in the incorporated '302 Patent or the like can be used in place of the abrasive material or material-removing pattern. In this case, the teeth extend inwardly rather than outwardly, as in the cutting device disclosed in the incorporated '302 Patent. The devices and structures used to hold and/or mount the cutting teeth disclosed in the incorporated '302 Patent can be used with the annular walls 222, 232 and/or 242 to connect the teeth to the inner surfaces 223, 233 and/or 243.

As shown in FIGS. 1-3, in some exemplary embodiments, each of the bevel cutting devices 220, 230 and 240 have a plurality of debris outlets or exits 228, 238 and 248, respectively, that allow the material removed from the pipe or other object, as the bevel is cut into that pipe or other object, to leave or exit the interior of that bevel cutting device 220, 230 or 240. That is, a substantial amount of loose or removed material is generated as debris as the bevel is cut into the pipe or other object by the bevel cutting device 220, 230 or 240. To allow such removed material to be removed from the interior of that bevel cutting device 220, 230 or 240, the debris outlets or exits 228, 238 and 248 are formed in the annular walls, 222, 232 and 242, respectively, and/or the bases 226, 236 and/or 246. In various exemplary embodiments, these debris outlets or exits 228, 238 and 248 extend through and at most partially up the annular walls 222, 232 and 242 and can extend through and at least a small distance into the base 226, 236 or 246.

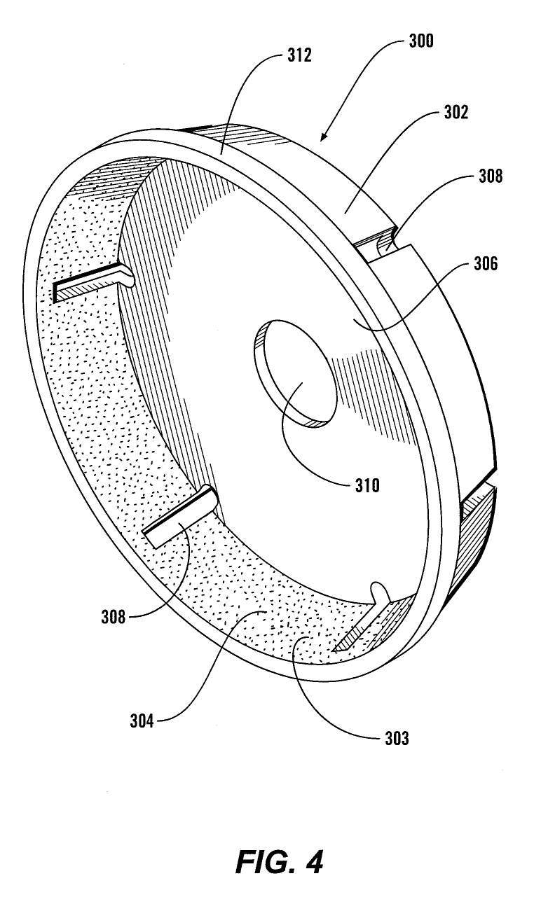

FIG. 4 is a side perspective view showing in greater detail a first exemplary embodiment of a single generic bevel cutter 300 according to this invention. As shown in FIG. 4, the first exemplary embodiment of the generic bevel cutter 300 includes an annular wall 302 that extends from a base 306. The annular wall 302 has an inwardly facing angled surface 303. An abrasive layer 304 is formed by embedding, coating, forming and/or attaching an abrasive material on, into and/or to the inwardly facing angled surface 303 of the annular wall 302. A plurality of debris outlets or exits 308 are formed in the annular wall 302. In various exemplary embodiments, the debris outlets or exits 308 extend through and at least part way up the annular wall 302 from the base 306. In various exemplary embodiments, the debris outlets or exits 308 can extend through and into the base 306. The debris outlets or exits 308 extend through the annular wall 302 and allow material removed from the pipe or other object, as the bevel is cut into the inserted end of that pipe or other object, to exit the interior of the bevel cutting device 300.

An adapter hole 310 is formed in the center of the base 306. As indicated above, the adapter hole 310 allows the bevel cutting device 300 to be inserted around the spindle adaptor 210. In various exemplary embodiments, the outer edge of the annular wall 302 includes a rim or ledge 312. The rim or ledge 312 adds strength and rigidity to the annular wall 302.

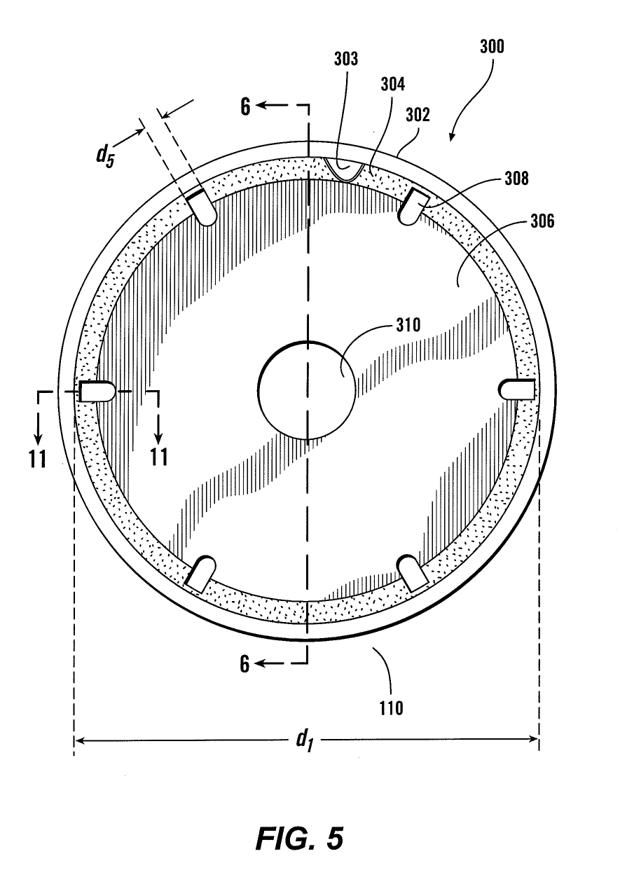

FIG. 5 is a top plan view of the first exemplary embodiment of the bevel cutting device 300 shown in FIG. 4. As shown in FIG. 5, the outer edge of the inwardly facing angled surface 303 has an outer diameter d₁. Accordingly, the outer diameter d₁ of a particular instance of the first exemplary embodiment of the bevel cutting device 300 defines the maximum outer diameter of the pipe or other object that that particular instance of the first exemplary embodiment of the bevel cutting device 300 can be used with, to cut a bevel into that end of that object. FIG. 5 also shows that the debris outlets or exits 308 have a circumferential width d₅. In various exemplary embodiments, the circumferential width d₅ is about one centimeter to about three centimeters.

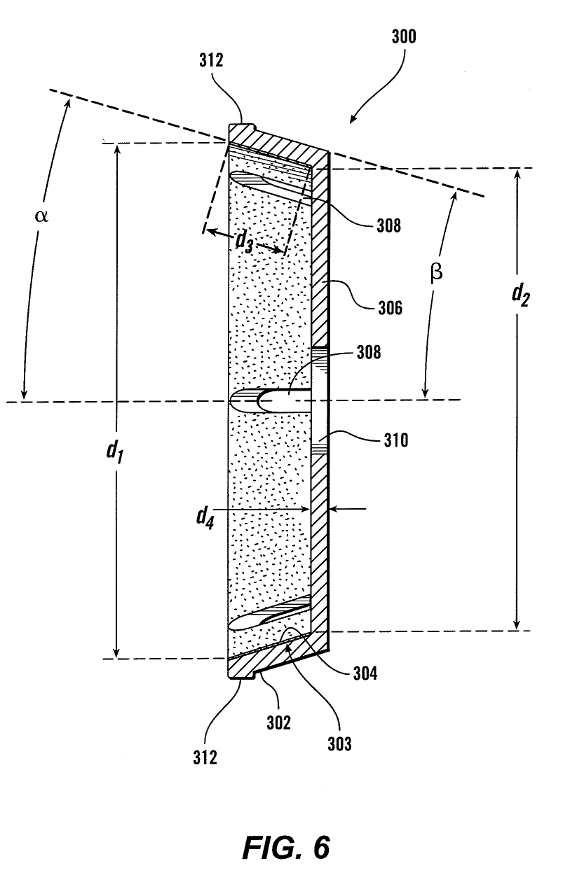

FIG. 6 shows a cross-sectional view of the first exemplary embodiment of the bevel cutting device 300 shown in FIGS. 4 and 5. As shown in FIG. 6, in addition to the outer diameter d₁, the first exemplary embodiment of the bevel cutting device 300 has an inner diameter d₂ at the inner edge of the annular wall 302 where it meets the base 306. The inwardly facing angled surface 303 of the annular wall 302 forms an angle a with a line that extends perpendicularly from the base 306 and an obtuse angle with the surface of the base 306. It should be appreciated that the inner diameter d₂ and the angle a define the depth and angle of the bevel that is cut into the pipe or other object when it is inserted into the bevel cutting device 300.

As shown in FIG. 6, the length of the inwardly facing angled surface 303, and thus the length of the abrasive layer 304 and the length of the bevel cut into the pipe or other object is shown as the length d₃. FIG. 6 also shows that the base 306 has a thickness d₄ while, in various exemplary embodiments, the outer surface of the annular wall 302 makes a second angle β with the line perpendicular to the base 306. It should be appreciated that, in various other exemplary embodiments, the outer surface of the annular wall 302 can extend at a right angle from the base 306. However, in such exemplary embodiments, the base of the annular wall 302 may desirably be thicker and thus require additional material. However, such a right-angled outer surface for the annular wall 302 can increase the strength and/or rigidity of the annular wall 302.

As shown in FIG. 6, the abrasive layer 304 is formed in or on, or is attached to, the inwardly facing angled surface 303 of the annular wall 302. It should be appreciated that the abrasive material used to form the abrasive layer 304 can be any known or later developed material having sufficient hardness to remove material from the particular pipe or other object that the first exemplary embodiment of the bevel cutting device 300 will be used to bevel. In various exemplary embodiments, the abrasive material is aluminum oxide or other hard material. It should also be appreciated that, in various exemplary embodiments, it is desirable that the abrasive material used to form the abrasive layer 304 generally readily release the material it removes from the pipe or other objects to be beveled, so that the removed material is able to disengage from the abrasive layer 304 and exit through one of the debris outlets or exits 308.

It should be appreciated that the abrasive can be associated with the inwardly facing angled surface 303 of the annular wall 302 in any appropriate known or later-developed manner. For example, in some exemplary embodiments, an abrasive material, such as, for example, aluminum oxide (corundum), garnet, steel grit and/or shot, iron grit and/or shot, nut shells (such as, for example, walnut shells), crushed slag (such as, for example, Black Beauty), silicon carbide, silicon oxide (i.e., glass), silicon nitride, zirconium oxide, tungsten carbides, other oxides, nitrides, carbides, and/or silicides, diamond and the like, is mixed into an epoxy material that is coated onto the inwardly facing angled surface 303.

In various other exemplary embodiments, the abrasive is mechanically manufactured, such as by thermally spraying an abrasive material onto the inwardly facing angled surface 303, by mechanically or chemically engraving the inwardly facing angled surface 303 (i.e., knurling), by adding and/or applying a post-formation surface treatment, such as, for example, thermal spraying, anodizing, heat treating and/or the like, to the engraved inwardly facing angled surface 303. In still other exemplary embodiments, the abrasive material can be chemically bonded to the inwardly facing angled surface 303, such as, for example, by using self-adhesive grit papers, by electroplating the abrasive material onto the inwardly facing angled surface 303, by using cemented/epoxied grits and/or the like.

It should be appreciated that, if the material of the pipe or other object to be beveled is relatively soft, abrasive materials other than aluminum oxide or the like may be suitable. In contrast, if harder materials, such as metals, vitreous clay or the like are used, harder materials, such as diamond grit, silicon carbide, other harder metals or other ceramics, or the like may be desirable.

As shown in FIGS. 5 and 6, the abrasive layer 304 extends generally continuously around the entire circumference of the inwardly facing angled surface 303 of the annular wall 302. However, it should be appreciated, that in various exemplary embodiments, the abrasive layer 304 does not need to be continuous. Rather, the abrasive layer 304 can be provided only at certain portions along the circumference of the inwardly facing angled surface 303 of the annular wall 302. It should further be appreciated that the annular wall 302 does not need to be continuous. Rather, in various exemplary embodiments, only a few spaced-apart portion or sectors of the annular wall 302 are provided, with the abrasive layer 304 provided on at least some of the portions or sectors.

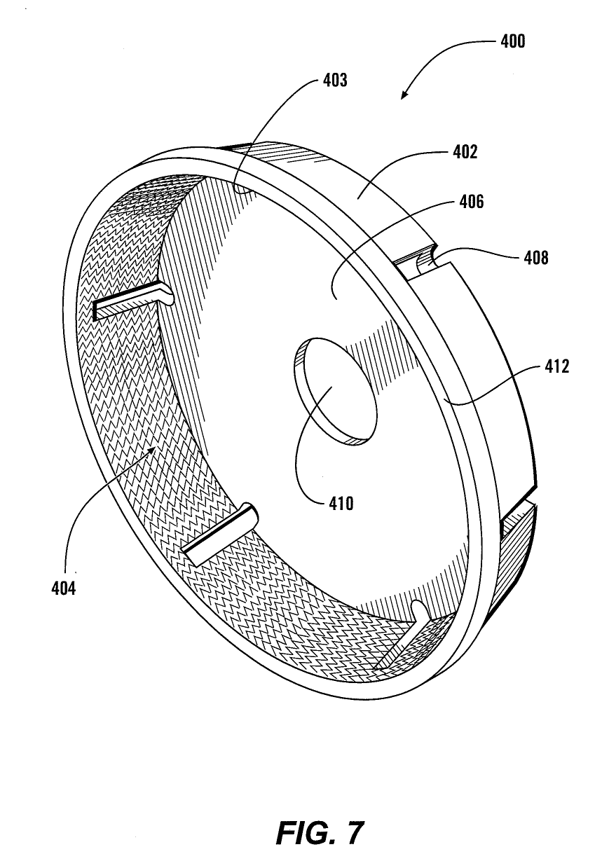

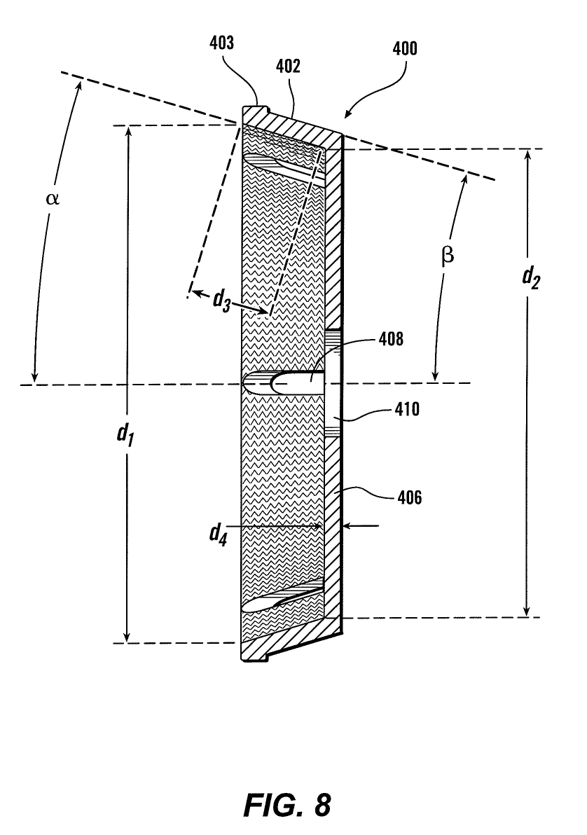

FIG. 7 shows a side perspective view of a second exemplary embodiment of a bevel cutting device 400 according to this invention. FIG. 8 shows a cross-sectional view of the second exemplary embodiment of the bevel cutting device 400 shown in FIG. 7, taken along the same line as the cross-sectional view shown in FIG. 6. As shown in FIGS. 7 and 8, the second exemplary embodiment of the bevel cutting device 400 includes an annular wall 402 extending from a base 406. The annular wall 402 has an inwardly facing angled surface 403 and a plurality of debris outlets or exits 408 that extend through the annular wall 402 and at least part-way up the annular wall 402 from the base 406 and can extend through and at least a small distance into the base 406.

Like the first exemplary embodiment of the bevel cutting device 300, the second exemplary embodiment of the bevel cutting device 400 includes an adapter hole 410 and a rim or ledge 412. However, unlike the first exemplary embodiment of the bevel cutting device 300 shown in FIGS. 4-6, in this second exemplary embodiment of the bevel cutting device 400, rather than an abrasive layer, the second exemplary embodiment of the bevel cutting device 400 includes a material removing pattern 404 formed in the inner surface 403 of the annular wall 402. It should be appreciated that this material removing pattern 404 can take any known or later-developed appropriate shape that adequately removes material from the inserted end of the pipe or other object to be beveled using the second exemplary embodiment of the bevel cutting device 400.

As shown in FIGS. 7 and 8, the material removing pattern 404 extends generally continuously around the entire circumference of the inwardly facing angled surface 403 of the annular wall 402. However, it should be appreciated, that in various exemplary embodiments, the material removing pattern 404 does not need to be continuous. Rather, the material removing pattern 404 can be provided only at certain portions of the circumference of the inwardly facing angled surface 403 of the annular wall 402. It should further be appreciated that the annular wall 402 does not need to be continuous. Rather, in various exemplary embodiments, only a few spaced-apart portion or sectors of the annular wall 402 are provided, with the material removing pattern 404 provided on at least some of the portions or sectors.

It should be appreciated that, in various exemplary embodiments, the material removing pattern 404 is a “rasp” or “file”-type pattern, similar to those patterns used on files or rasps used to work wood or metal. In various other exemplary embodiments, the material removing pattern 404 can be a “cheese-grater”-type pattern or the like. It should be appreciated that different instances of the second exemplary embodiment of the bevel cutting device 400 can have different types of material removing patterns 404, with a particular instance of the second exemplary embodiment of the bevel cutting device 400 selected based on the material of the pipe or other object to be beveled using that particular instance of the second exemplary embodiment of the bevel cutting device 400. In general, the material used to form a particular instance of the second exemplary embodiment of the bevel cutting device 400 will need to be harder than the material used to form the pipe or other object to be beveled.

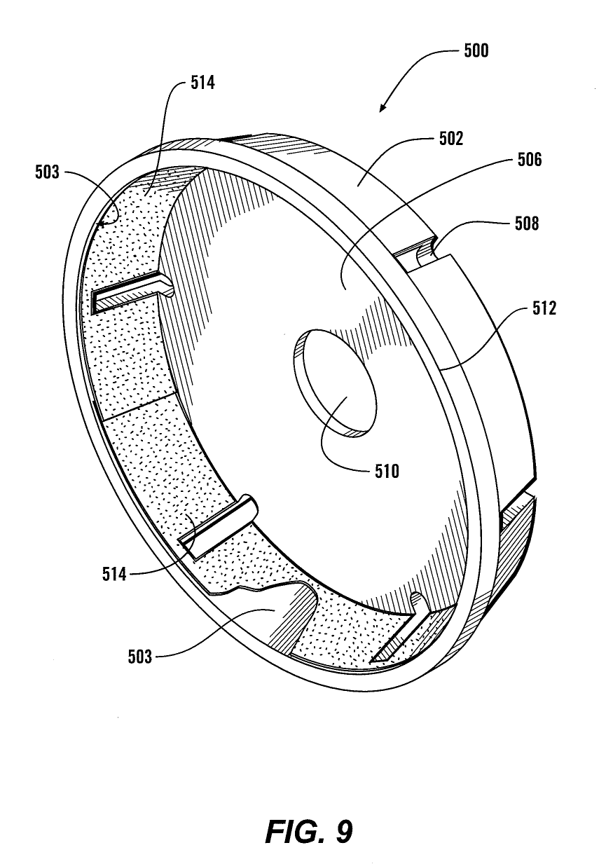

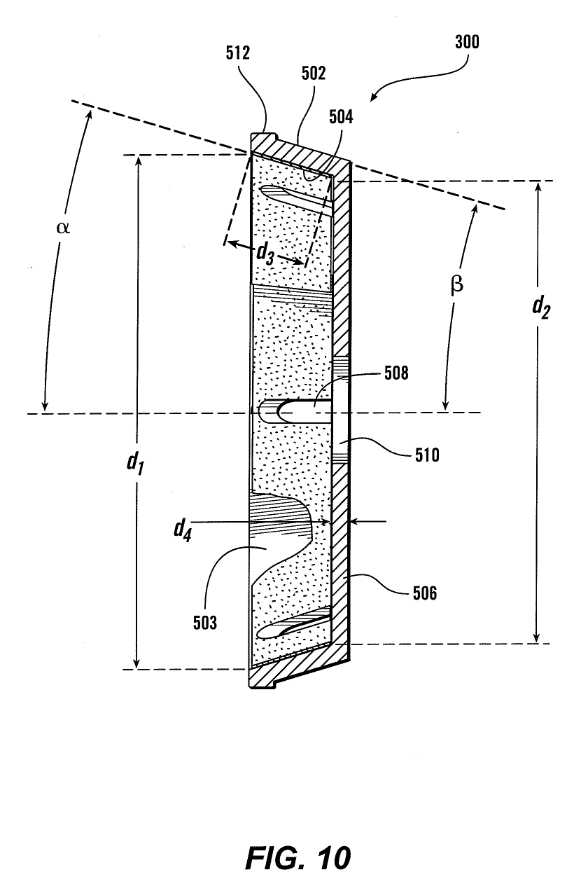

FIG. 9 is a side perspective view of a third exemplary embodiment of a bevel cutting device 500 according to this invention. FIG. 10 is a cross-sectional view of the third exemplary embodiment of the bevel cutting device 500 shown in FIG. 9 taken along the line used to form the side cross-sectional view shown in FIG. 6. As shown in FIG. 9, the third exemplary embodiment of the bevel cutting device 500 includes an annular wall 502 that extends from a base 506 and that has an inwardly facing angled surface 503. A plurality of debris outlets or exits 508 extend through the annular wall 502 at least part-way up the inwardly facing angled surface 503 and can extend through and at least a small distance into the base 506. An adaptor hole 510 is located at the center of the base 506, while the annular wall 502 has a rim or ledge 512.

However, unlike the first exemplary embodiment of the bevel cutting device 300 shown in FIGS. 4-6, rather than an attached or embedded abrasive layer 304, this third exemplary embodiment of the bevel cutting device 500 includes a removable or detachable layer 514 that can be removably or detachably, yet securely, attached to the bevel cutting device 500. It should be appreciated that the inner surface of this removable or detachable layer 514 includes either an abrasive material or a material removing pattern as outlined above with respect to the abrasive layer 304 and the material removing pattern 404. It should be appreciated that the same general considerations outlined above with respect to the abrasive layer 304 and/or the material removing pattern 404 generally apply to the removable or detachable layer 514.

In various exemplary embodiments, the removable or detachable layer 514 is attached to the inwardly facing angled surface 503 using an adhesive. It should be appreciated, that, in such exemplary embodiments, it is desirable that the adhesive securely attach the removable or detachable layer 514 to the inwardly facing angled surface 503 such that it is not, or does not become, dislodged or detached while the third exemplary embodiment of the bevel cutting device 500 is cutting a bevel into a pipe or other object. It is further desirable, in such exemplary embodiments, that the adhesive allow a used removable or detachable layer 514 that the user desires to remove and replace to be relatively readily or easily detached from the inwardly facing angled surface 503 at that time.

In various other exemplary embodiments, mechanical fasteners, such as clips or any other known or later-developed fastening device, are used to securely hold the strip 514 to the third exemplary embodiment of the bevel cutting device 500. For example, such clips could extend into the debris outlets or exits 508 and around either or both of the outer surface of the annular wall 502 and/or the bottom surface of the base 506. It should be appreciated that any appropriate manner of attaching the removable or detachable layer 514 to the third exemplary embodiment of the bevel cutting device 500, that also allows the removable or detachable layer 514 to be readily removed from the third exemplary embodiment of the bevel cutting device 500, can be used.

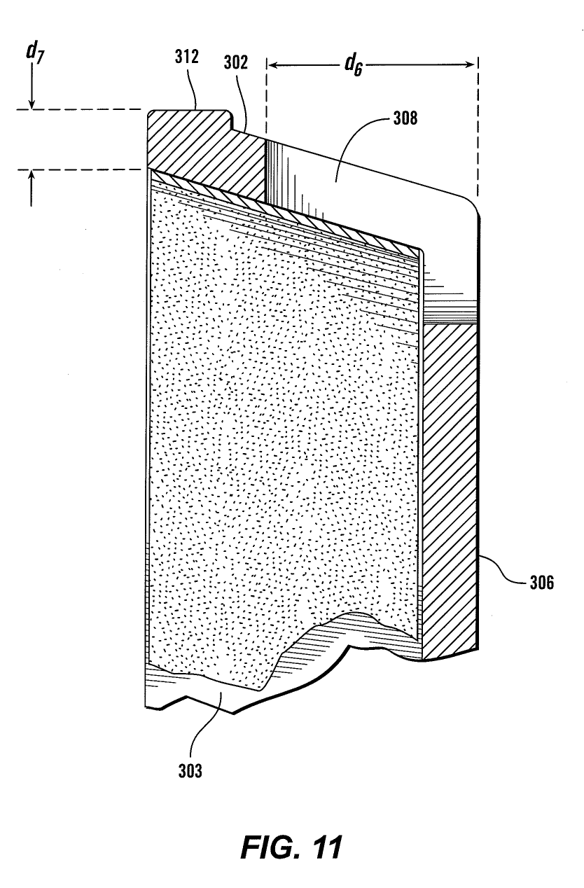

FIG. 11 shows a cross-sectional view of one exemplary embodiment of a debris outlet or exit 308. As shown in FIG. 11, the debris outlet or exit 308 is formed both in the annular wall 302 and the base 306 and has a height d₆ from the outer surface of the base 306 to the top of the debris outlet or exit 308 in the annular wall 302. FIG. 11 also shows that the rim or ledge 312 formed at the outer edge of the annular wall 302 has a thickness d₇.

It should be appreciated that the various bevel cutting devices 220-240, 300, 400 and 500 outlined above can be made using any suitable material. In the exemplary embodiments shown in FIGS. 1-3, the bevel cutting devices 220-240 are formed from aluminum. In various exemplary embodiments, the bevel cutting devices 220-240 can be formed by milling them out of a billet of aluminum or can be formed by casting aluminum into molds. In various other exemplary embodiments, the bevel cutting devices 220-240, 300, 400 and/or 500 can be formed using any appropriate thermoform or thermoset plastic material, and can be formed using injection molding or the like.

In the various exemplary embodiments shown in FIGS. 1-10, the bases 226, 236, 246, 306, 406 and 506 are shown as being generally solid and continuous, except for the spindle adaptor holes formed to allow these bevel cutting devices 220-240, 300, 400 and/or 500 to be placed over the spindle adapter 210. However, it should be appreciated, in various exemplary embodiments, various voids and the like can be formed in the bases 226, 236, 246, 306, 406 and/or 506 to save material and/or weight. For example, in one such exemplary embodiment, a base 226, 236, 246, 306, 406 or 506 could be formed having an inner hub in which the adaptor hole is formed, an outer rim from which the annular wall extends and a plurality of spokes that extend between the center hub and the outer rim.

It should further be appreciated that the base and the annular wall can be formed as a single, integral piece, as shown in FIGS. 4-10. Alternatively, in other various exemplary embodiments, the annular wall and the base can be formed as separate pieces, that are later attached or connected using any appropriate fasteners, adhesives or connection structure or technique. Such techniques can include bolts or screws, welding, brazing or the like.

It should be appreciated that various different instances of any of the generic bevel cutting devices 300-500 having different diameters can be combined into a bevel cutting system 200. Generally, smaller-diameter instances will be nested into larger-diameter instances of a bevel cutting device 300-500. Many types of objects, such as pipes, come in standard diameters. For example, PVC water main pipes 10 come in 4-inch, 6-inch and 8-inch diameter versions, as well as larger diameter versions, including 12-inch, 24-inch and 36-inch diameter versions. The bevel cutting systems 200 shown in FIGS. 1-3 is particularly useful to bevel such 4-inch, 6-inch and 8-inch diameter versions of water main pipe 10, using the bevel cutting devices 240, 230 and 220, respectively. However, it should be appreciated that the diameter of a generic bevel cutting device is not limited to these diameters.

While this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

1. A bevel cutting device, comprising
a base;
an annular wall extending from the base, an inner surface of the annular wall extending from the base at an obtuse angle; and
a cutting structure associated with the inner surface of the annular wall.

2. The bevel cutting device of claim 1, further comprising a plurality of apertures formed in the annular wall.

3. The bevel cutting device of claim 2, wherein, when the bevel cutting device is used to cut a bevel into an object inserted into the bevel cutting device, the cutting structure removes material from the inserted object, the removed material passing through the plurality of apertures.

4. The bevel cutting device of claim 1, wherein the cutting structure comprises a layer of abrasive material provided on the inner surface of the annular wall.

5. The bevel cutting device of claim 4, wherein the layer of abrasive material comprises a sheet of material on which an abrasive substance is provided, the sheet of material attached to the inner surface of the annular wall.

6. The bevel cutting device of claim 5, wherein the sheet of material is attached to the inner surface of the annular wall by an adhesive.

7. The bevel cutting device of claim 5, wherein the sheet of material is detachably attached to the inner surface of the annular wall.

8. The bevel cutting device of claim 5, wherein the sheet of material is mechanically attached to the inner surface of the annular wall.

9. The bevel cutting device of claim 4, wherein the layer of abrasive material provided on the inner surface of the annular wall is a layer of abrasive material that is embedded into the inner surface of the annular wall.

10. The bevel cutting device of claim 4, wherein the layer of abrasive material provided on the inner surface of the annular wall is a coating, containing abrasive material, that is applied into the inner surface of the annular wall.

11. The bevel cutting device of claim 1, wherein the cutting structure comprises a material removing pattern that is formed in the inner surface of the annular wall.

12. The bevel cutting device of claim 1, wherein the cutting structure comprises a layer of material attached to the inner surface of the annular wall, a material removing pattern formed in the layer of material.

13. The bevel cutting device of claim 1, wherein the annular wall comprises a plurality of spaced apart portions.

14. The bevel cutting device of claim 1, wherein the base has an aperture usable to connect the bevel cutting device to a rotating element.

15. A bevel cutting system, comprising:
a spindle adaptor having:
a base,
a spindle mounting hole in the base,
an annular wall extending from the base, a thread formed in an outer surface of the annular wall;
at least one bevel cutting device, each bevel cutting device comprising:
a base having an aperture, wherein the base can be placed onto the spindle adaptor such that the spindle adaptor extends through the aperture in the base,
an annular wall extending from the base, an inner surface of the annular wall extending from the base at an obtuse angle, and
a cutting structure associated with the inner surface of the annular wall; and
a nut that can be screwed onto the spindle adaptor, the nut usable to hold the at least one bevel cutting device placed onto the spindle adaptor against the base of the spindle adaptor.

16. The bevel cutting system of claim 15, wherein:
the at least one bevel cutting device comprises a plurality of bevel cutting devices, each bevel cutting device having a different diameter; and
when the plurality of bevel cutting devices are mounted onto the spindle adaptor, a first bevel cutting device having a smaller diameter is located radially within the annular wall of a second bevel cutting device having a larger diameter.

17. The bevel cutting system of claim 15, further comprising a rotary device having a spindle, the spindle having a threaded outer surface, wherein the spindle adaptor is placed on to the spindle such that the spindle extends through the aperture in the base of the spindle adaptor, a nut threaded onto the spindle to hold the spindle adaptor to the spindle.

18. The bevel cutting system of claim 17, wherein the rotary device further comprises a cutting blade mounted on the spindle behind the spindle adaptor.

19. A method for beveling an object using a bevel cutting device having a base, an annular wall extending from the base, an inner surface of the annular wall forming an obtuse angle with the base, a cutting structure associated with the inner surface of the annular wall, the method comprising:
rotating at least one of the bevel cutting device and the object;
inserting an end of the object into the bevel cutting device radially within the annular wall;
contacting a portion of the inserted end of the object against the cutting structure; and
removing material from the contacted portion of the inserted end of the object using the cutting structure.

20. The method of claim 19, further comprising:
continuing the inserting, contacting and removing steps until the inserted end of the object contacts the base of the bevel cutting device; and
removing the inserted end of the object from the bevel cutting device, wherein a bevel has been cut into the inserted end of the object.
